(19) United States
(12) Patent Application Publication
(10) Pub. No.: US 2013/0140364 A1
(43) Pub. Date: Jun. 6, 2013

(54) SYSTEMS AND METHODS FOR DETECTING AND PREVENTING TAMPERING OF CARD READERS

(71) Applicant: Magtek, Inc., Seal Beach, CA (US)

(72) Inventors: Justin F. McJones, Rancho Palos Verdes, CA (US); Jeff R. Duncan, Rancho Palos Verdes, CA (US)

(73) Assignee: MAGTEK, INC., Seal Beach, CA (US)

(21) Appl. No.: 13/681,284

(22) Filed: Nov. 19, 2012

Related U.S. Application Data
(60) Provisional application No. 61/565,853, filed on Dec. 1, 2011.

(51) Int. Cl. G06K 7/08

(52) U.S. Cl. CPC G06K 7/082
USPC 235/449

(57) ABSTRACT

Systems and methods for detecting and preventing tampering of card readers are provided. In one embodiment, the invention relates to a secure card reader for detecting and preventing tampering, the secure card reader comprising a reading head configured to extract recorded data from a data card, a processing circuitry coupled to the reading head, at least one printed circuit board comprising an inner surface and an outer surface, wherein the inner surface is closer to the processing circuitry than the outer surface, at least one secure trace coupled to the processing circuitry, and a security mesh coupled to the processing circuitry, wherein the security mesh is disposed between the secure trace and the outer surface, and a housing, wherein the housing and the at least one printed circuit board form a compartment substantially enclosing the processing circuitry.

### CROSS-REFERENCE TO RELATED APPLICATION(S)

The present application claims priority to and the benefit of Provisional Application No. 61/565,853, filed Dec. 1, 2011, entitled, “SYSTEMS AND METHODS FOR DETECTING AND PREVENTING TAMPERING OF CARD READERS”, the entire content of which is incorporated herein by reference.

### FIELD

The present invention relates generally to card reader systems, and more specifically to systems and methods for detecting and preventing tampering of card readers.

### BACKGROUND

Card readers for facilitating various transactions have become central features of modern life and are prevalent in a number of environments. For example, during the course of a day, a user may use a card reader to conduct financial transactions at an automated teller machine, purchase gas from a point of sale terminal in the form of a fuel pump using a credit or debit card, and purchase food at the grocery store using a point of sale terminal also with a credit or debit card. In all of these instances, security is a prime concern, and an individual's data (card number, passwords, account numbers, etc.) should be kept secure and away from unintended parties. Efforts to obtain the financial information of others through tampering at these various sites employing card readers have become prevalent. As such, there is a need to counter and minimize the ability of unauthorized parties to obtain confidential information by tampering with card readers.

### SUMMARY

Aspects of the invention relate to systems and methods for detecting and preventing tampering of card readers. In one embodiment, the invention relates to a secure card reader for detecting and preventing tampering, the secure card reader comprising a reading head configured to extract recorded data from a data card, a processing circuitry coupled to the reading head, at least one printed circuit board comprising an inner surface and an outer surface, wherein the inner surface is closer to the processing circuitry than the outer surface, at least one secure trace coupled to the processing circuitry, and a security mesh coupled to the processing circuitry, wherein the security mesh is disposed between the secure trace and the outer surface, and a housing, wherein the housing and the at least one printed circuit board form a compartment substantially enclosing the processing circuitry.

In another embodiment, the invention relates to a secure card reader for detecting and preventing tampering, the secure card reader comprising a reading head configured to extract recorded data from a data card, a processing circuitry coupled to the reading head, a first printed circuit board and a second printed circuit board, each comprising an inner surface and an outer surface, wherein the inner surface is closer to the processing circuitry than the outer surface, at least one secure trace coupled to the processing circuitry, and a security mesh coupled to the processing circuitry, wherein the security mesh is disposed between the secure trace and the outer surface, and a housing, wherein the housing and the first printed circuit board and the second printed circuit board form a compartment substantially enclosing the processing circuitry.

### BRIEF DESCRIPTION OF THE DRAWINGS

FIG. 1 is a schematic block diagram of a secure card reader system for detecting and preventing tampering in accordance with one embodiment of the present invention.

FIG. 2 is a schematic block diagram of a secure card reader system for detecting and preventing tampering in accordance with another embodiment of the present invention.

FIG. 3 is a perspective view of a secure fuel pump insertion card reader for detecting and preventing tampering including a front compartment enclosing a magstripe reader and a rear compartment formed of a left printed circuit board (PCB), a U-shaped housing and a right PCB (not visible but see FIG. 5) in accordance with one embodiment of the present invention.

FIG. 4 is a perspective view of the secure fuel pump insertion card reader of FIG. 3 with various components removed to illustrate an inside surface of the left PCB of the reader including a processor coupled to various tamper detection devices using one or more secure traces in accordance with one embodiment of the present invention.

FIG. 5 is a perspective view of the secure fuel pump insertion card reader of FIG. 3 with various components removed to illustrate the outside surface of the left PCB and a security mesh positioned on the outside surface of the left PCB for detecting tampering in accordance with one embodiment of the present invention.

FIG. 6 is a perspective view of the secure fuel pump insertion card reader of FIG. 3 with various components removed and the left PCB made transparent to illustrate a zebra connector, a microswitch and a first push button sensor on the right PCB for detecting tampering in accordance with one embodiment of the present invention.

FIG. 7 is a perspective view of the secure fuel pump insertion card reader of FIG. 3 with various components removed and the U-shaped housing made transparent to illustrate the orientation of the microswitch and various push button sensors in accordance with one embodiment of the present invention.

FIG. 8 is a perspective view of the secure fuel pump insertion card reader of FIG. 3 with U-shaped housing and right PCB made transparent to illustrate the microswitch and various push button sensors in accordance with one embodiment of the present invention.

### DETAILED DESCRIPTION

Referring now to the drawings, embodiments of secure card readers employing various security features to detect and prevent tampering are illustrated. The secure card readers include processing circuitry protected by at least one printed circuit board and a housing and coupled to a card reader. The printed circuit board includes a security mesh on or near an outer surface thereof and at least one secure trace, where the security mesh is positioned between the outer surface and the secure trace. Together the printed circuit board and housing form a compartment that substantially encloses the processing circuitry.

In some embodiments, the secure card readers include first and second printed circuit boards positioned to be parallel to one another and to protect the processing circuitry in conjunction with the housing. Additional tamper detection components can be installed at various locations along the secure card reader. The components can include a push button sensor, a zebra connector, a microswitch, or other suitable tamper detection component. If any of the tamper detection components, including the security mesh, reports information indicative of tampering, the processing circuitry can take appropriate measures to protect itself. These measures can include erasing memory, rending itself inoperable, and other appropriate protective measures.

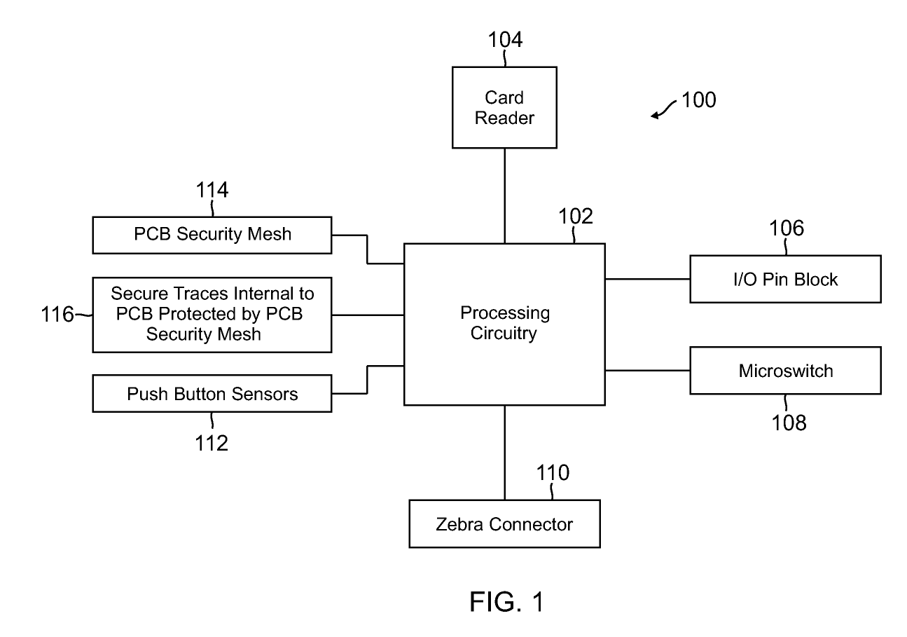

FIG. 1 is a schematic block diagram of a secure card reader system 100 for detecting and preventing tampering in accordance with one embodiment of the present invention. The system 100 includes processing circuitry 102 coupled to a card reader 104, an input/output (I/O) pin block 106, a microswitch 108, a zebra connector 110, one or more push button sensors 112, a printed circuit board (PCB) mesh 114, and one or more secure traces 116 internal to the PCB protected by the PCB security mesh 114. In operation, the card reader 104 can extract information from a data card.

In one embodiment, the card reader 104 is a magstripe reader configured to extract information from the magnetic medium of the data card. As such, the information read from the magstripe data card can include a payment account number (PAN), other information commonly stored on track 1 or track 2 of a magstripe payment card, and a magnetic fingerprint indicative of an intrinsic magnetic characteristic of the magnetic medium of the magstripe card. Techniques for extracting and comparing magnetic fingerprints are described in U.S. Pat. Nos. 6,098,881, 7,478,751, 7,210,627, and 7,377,433 and U.S. patent application Ser. Nos. 11/949,722, and 12/011,301, the entire content of each document is hereby incorporated by reference. In another embodiment, the card reader 104 is a smart card reader, or a contact block for establishing electrical contact with a smart card where the processing circuitry 102 includes an ability to extract information from the smart card via the contact block. In some embodiments, the secure card reader system 100 includes both a magstripe reader and a smart card reader.

In several embodiments, the I/O pin block 106 provides a physical communication interface through which a number of signals indicative of the information extracted from one or more data cards can be communicated. In many embodiments, the extracted data card information is encrypted using one or more encryption keys for obfuscating confidential card holder or transaction information. In several embodiments, the microswitch 108 is positioned along a housing or a printed circuit board associated with the card reader system 100 and can detect removal of, or tampering with, a system component such as a housing or a PCB (e.g., unauthorized removal of the system component). In several embodiments, the zebra connector 110 is a multi-contact elastomeric connector having alternating conductive and insulating materials where the electrical connections to the conductive materials/contacts can be sustained through continued application of pressure and/or contact by a mating connector or PCB.

The one or more push button sensors 112 can be positioned at various locations along the card reader system 100 for detecting tampering. One or more of the components in the card reader system 100 are mounted on or routed through a PCB. In order to protect the components from potential tampering, the PCB security mesh 114 can be located at or near an outside surface of the PCB (e.g., outer surface of the card reader system 100). The security mesh 114, possibly in conjunction with the processing circuitry 102, can detect when someone attempts to tamper with components on the inside surface of the PCB by for example, drilling through, or cutting away a portion of, the PCB. In theory, the security mesh 114 can detect any attempted penetration of the PCB by covering much or all of the surface area of the PCB. The secure traces 116 are positioned on the inside surface of the PCB (e.g., surface facing components on the inside of the reader) or on a layer internal to the PCB. In such case, the secure mesh 114 is positioned between the outside surface of the PCB and the secure traces 116 or on the outside surface. In this way, the security mesh 114 can help prevent an attacker from gaining access to the secure traces 116 or other components located on the inside surface of the PCB. In a number of embodiments, many of the component to component electrical connections in the secure card reader 100 can be implemented using the secure traces 116.

In several embodiments, the processing circuitry 102 is implemented using one or more processing components that share information (e.g., processors, microprocessors, and/or various programmable logic devices). For example, the processing circuitry 102 can include one or more secure processors that are configured to react to suspected/detected tampering by erasing preselected information from memory and/or rendering themselves partially or completely inoperable. In one embodiment, for example, the secure processor can erase encryption keys or other information that might be considered confidential or sensitive. In some embodiments, the system 100 can include one or more volatile or non-volatile memory components that store information accessible to the processing circuitry and/or other components.

In one embodiment, the processor circuitry 102 responds to a breach or attempted breach by communicating the breach or attempted breach to devices connected to the magnetic read head. In one embodiment, the processor disables itself. In another embodiment, the processor erases all of its executable code stored in memory or elsewhere. In yet another embodiment, the processor reduces itself to a pseudo functional state where the only function the processor performs is reporting the breach or attempted breach. In such case, the processor can also report the type or method of the breach or attempted breach. In one embodiment of the pseudo functional state, only the executable code required to function in the pseudo functional state is preserved while all other information is erased.

In the embodiment illustrated in FIG. 1, the secure card reader system 100 includes a single security mesh 114, zebra connector 110 and microswitch 108. In other embodiments, the system can include more than one of these components. In other embodiments, the secure card reader system 100 can include other tamper detection devices known in the industry.

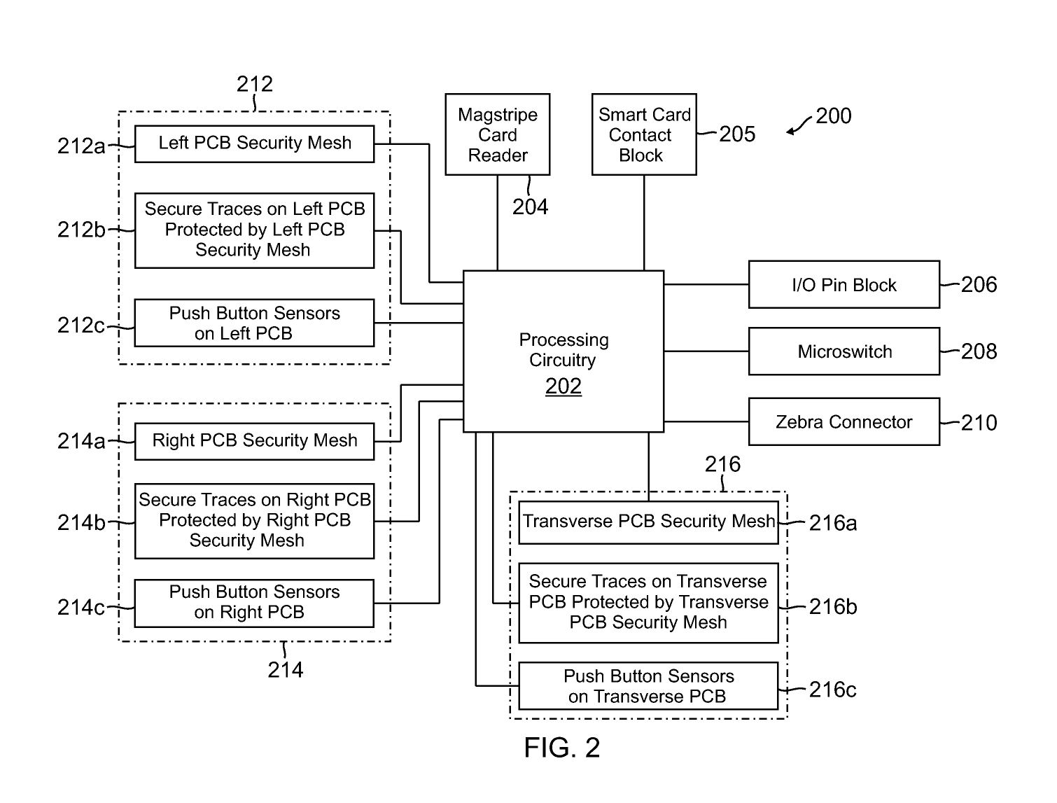

FIG. 2 is a schematic block diagram of a secure card reader system 200 for detecting and preventing tampering in accordance with another embodiment of the present invention. The system 200 includes processing circuitry 202 coupled to a magstripe card reader 204, a smart card contact block 205, an input/output pin block 206, a microswitch 208, and a zebra connector 210. The processing circuitry 202 is also coupled to a left PCB security mesh 212a on a left PCB 212, secure traces 212b on the left PCB 212 protected by the left PCB security mesh 212a, push button sensors 212c on the left PCB 212, a right PCB security mesh 214a on a right PCB 214, secure traces 214b on the right PCB 214 protected by the right PCB security mesh 214a, push button sensors 214c on the right PCB 214, a transverse PCB security mesh 216a on a transverse PCB 216, secure traces 216b on the transverse PCB 216 protected by the transverse PCB security mesh 216a, and push button sensors 216c on the transverse PCB 216. In a number of embodiments, the components of the secure card reader system 200 can function in the same manner described above for FIG. 1, and the system can include the alternative embodiments described above for FIG. 1.

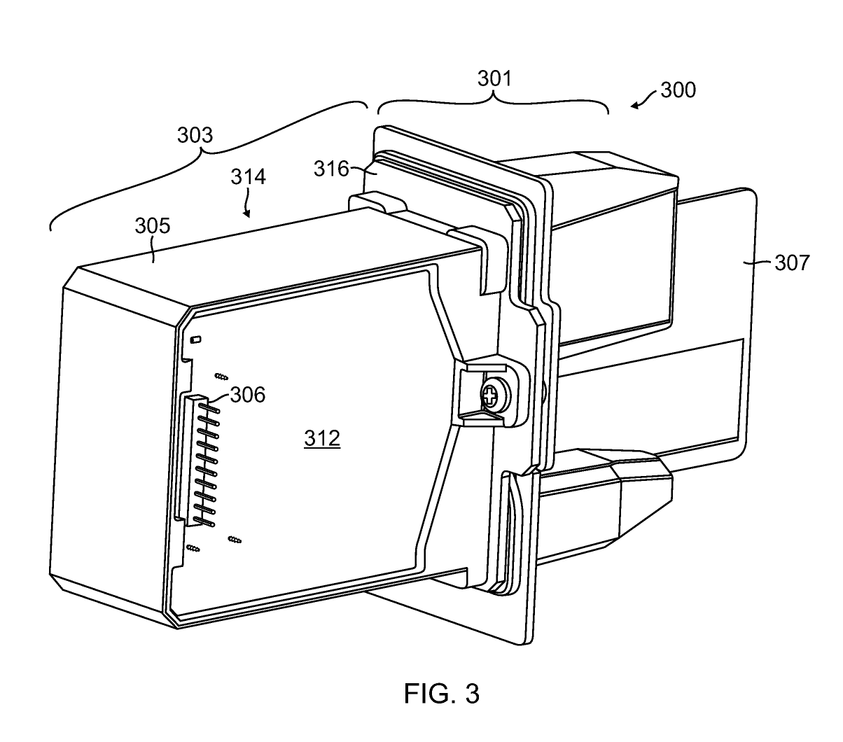

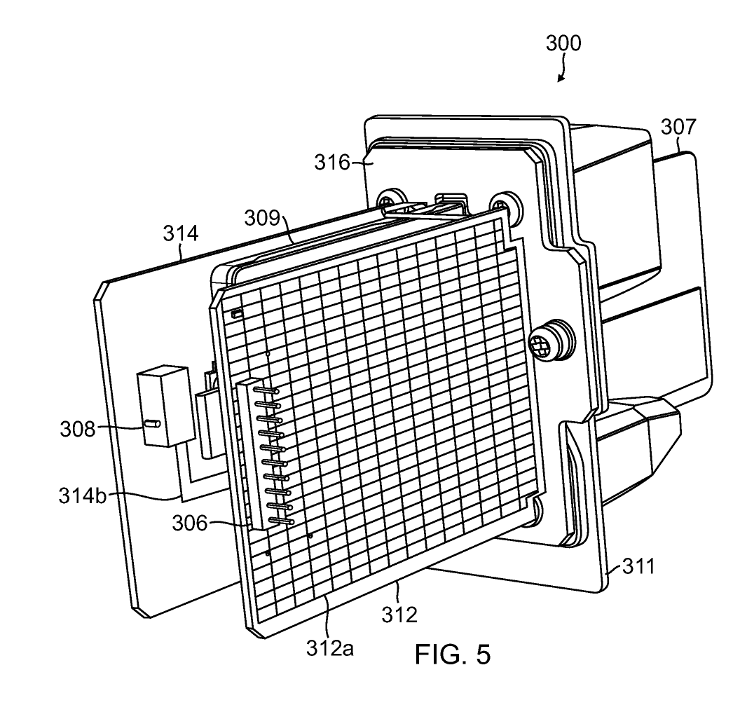

FIG. 3 is a perspective view of a secure fuel pump insertion card reader 300 for detecting and preventing tampering including a front compartment 301 enclosing a magstripe reader (not visible but positioned within upper bezel) and a rear compartment 303 formed of a left PCB 312, a U-shaped housing 305 and a right PCB 314 (not visible but see FIG. 5) in accordance with one embodiment of the present invention. The secure fuel pump reader 300 also includes a transverse PCB 316 positioned along a dividing plane separating the front compartment 301 and the rear compartment 303. In a number of embodiments, the front compartment 301 would be mounted such that it remains outside of a fuel pump housing, while the rear compartment 303, including the transverse PCB 316 is mounted within the fuel pump housing. For security reasons, the inside of the fuel pump housing is meant to be kept relatively secure. However, enterprising thieves may try to gain access to the inside of the fuel pump housing to steal information from the rear compartment 303 of the reader 300. The terms “left” and “right” as used in conjunction with the PCBs of the card reader 300 mean left and right while viewing the front compartment 301 of the reader positioned on the outside of the fuel pump housing.

A data card 307 is shown positioned in a card path of the reader 300. In some embodiments, the data card can be a magstripe card capable of storing information on a magnetic medium. In some embodiments, the data card can be a smartcard capable of storing information on one or more chips embedded within the data card. In such case, the information may be read by contacting a number of conductive terminals on the card using the appropriate protocols for accessing such stored information, as is known in the art. In a number of embodiments, the rear compartment 303 can contain a smart card reader. A I/O pin block 306 is mounted on the left PCB 312 and can be used to communicate with the secure card reader system 300.

In several embodiments, a schematic block diagram of the components of the secure fuel pump insertion card reader 300 is roughly equivalent to the schematic block diagram of FIG. 2.

In the embodiment illustrated in FIG. 3, the U-shaped housing 305, the left PCB 312, the right PCB 314, and the transverse PCB 316 effectively form a secure enclosure that protects a number of electronic components (e.g., processing circuitry) that could potentially be targeted by an attacker. In other embodiments, a single PCB can be used, possibly at the side or a predetermined location indicative of the greatest threat from intruders. In a number of embodiments, each of the PCBs includes a security mesh on an outer surface thereof, or within the respective PCB (see for example FIG. 5). The security mesh, in conjunction with processing circuitry such as a microprocessor, can detect any number of different techniques for tampering and attempting to gain access to the rear compartment of the reader involving penetration of the respective PCB employing the security mesh.

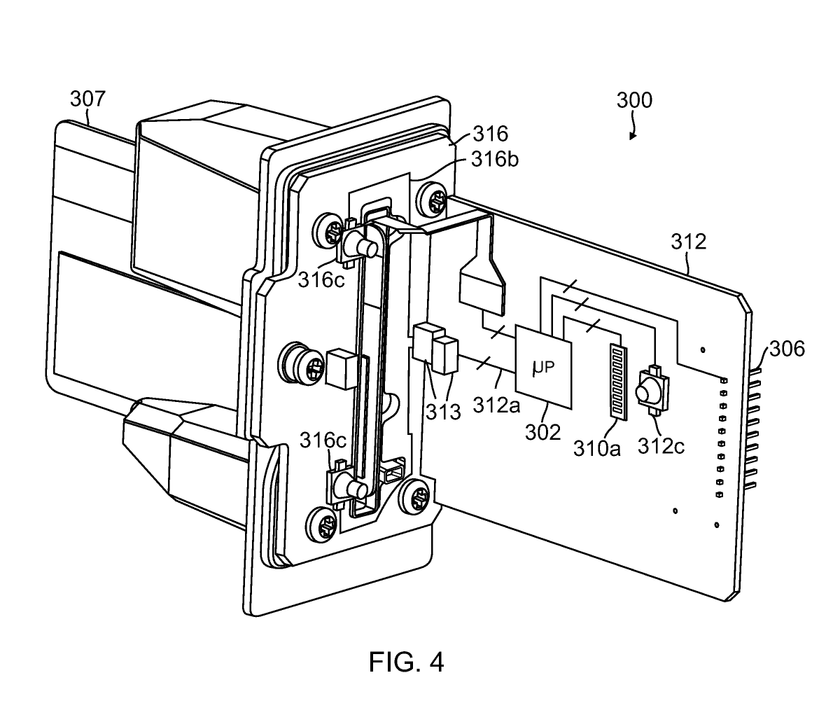

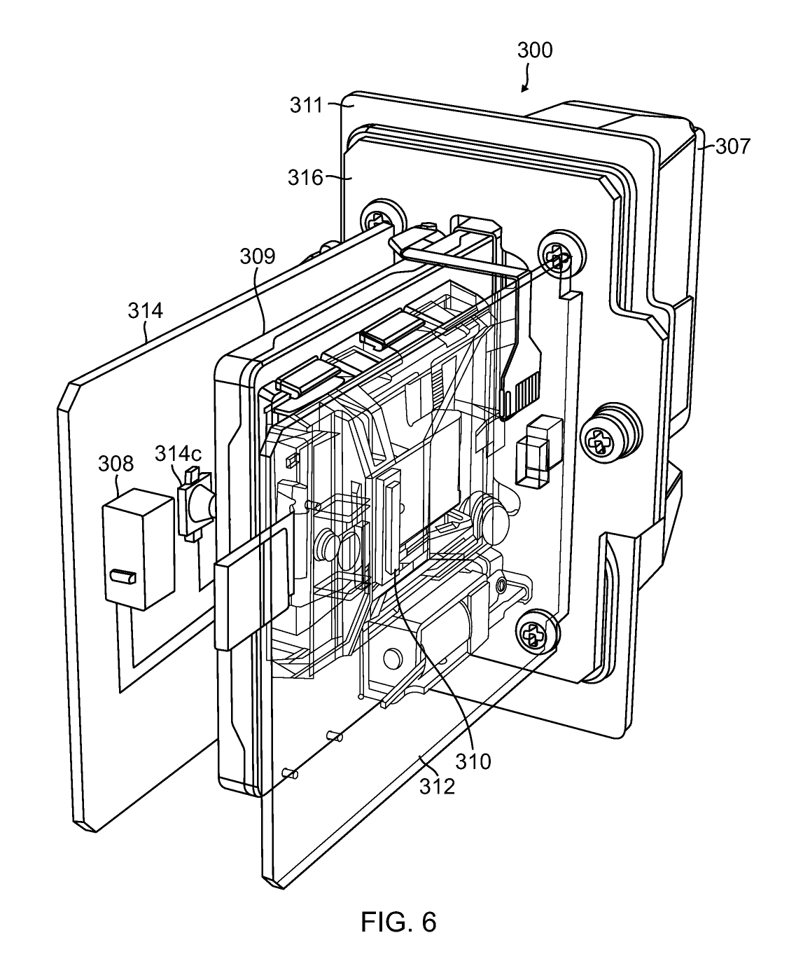

FIG. 4 is a perspective view of the secure fuel pump insertion card reader 300 of FIG. 3 with various components removed to illustrate an inside surface of the left PCB 312 of the reader including a processor 302 coupled to various tamper detection devices using one or more secure traces 312a in accordance with one embodiment of the present invention. The processor 302 is also coupled, via one or more secure traces, to a pad layout 310a for physically and electrically contacting a zebra connector (not visible in FIG. 4 but see FIG. 6), a push button sensor 312c, and the I/O pin block 306. The processor 302 is also coupled to push button sensors 316c via secure traces 316b on the transverse PCB 316 and a board to board interconnect 313. In several embodiments, the push button sensor 312c is optional and can be removed from the left PCB 312.

In a number of embodiments, additional components may be mounted to the inside surface of the left PCB 312 and/or on the inside surface of the transverse PCB 316. In some embodiments, the processor 302 can be located on another PCB such as the transverse PCB 316 or the right PCB 314 (not visible in FIG. 4 but see FIG. 5). In the embodiment illustrated in FIG. 4, the secure traces 312a are shown as being on the inside surface of the left PCB. In other embodiments, the secure traces may be positioned on an internal layer of the left PCB. In the embodiment illustrated in FIG. 4, a particular number of the secure traces 312a are shown as being on the inside surface of the left PCB 312. In other embodiments, there may be additional traces on the left PCB, right PCB or transverse PCB. In several such embodiments, the secure mesh is positioned on an outside surface of the left PCB 312 or such that the secure mesh 312a (not visible in FIG. 4 but see FIG. 5) is positioned on an internal layer between the secure traces (e.g., on the inside surface or an internal layer of the left PCB 312) and an outside layer of the left PCB 312.

FIG. 5 is a perspective view of the secure fuel pump insertion card reader 300 of FIG. 3 with various components removed to illustrate the outside surface of the left PCB 312 and a security mesh 312a positioned on the outside surface of the left PCB 312 for detecting tampering in accordance with one embodiment of the present invention. While the security mesh 312a is shown as being positioned on the outside surface of the left PCB 312 for ease of illustration, in many embodiments, the security mesh 312a is positioned on an internal layer of left PCB 312. In such case, the security mesh 312a can be more difficult to observe, access, and/or defeat. The card reader 300 also includes the right PCB 314 and the transverse PCB 316, where the right PCB 314 and left PCB 312 are oriented to be parallel to each other and perpendicular to the transverse PCB 316.

A microswitch 308 and one or more secure traces 314b are positioned on an inside surface of the right PCB 314 facing the left PCB 312 and coupled to a processor 302 (not visible in FIG. 5 but see FIG. 4). A security mesh (not visible) for the right PCB 314 is positioned on, or near, the outside surface of the right PCB 314. The security mesh for the transverse PCB 316 can be located on or near a surface of the PCB 316 closest to the front compartment 301 (e.g., front of the secure card reader). A card slot housing 309 is positioned between the left PCB 312 and the right PCB 314 and may extend into or through the transverse PCB 316. In other embodiments, the left PCB 312 and the right PCB 314 may be mounted to the transverse PCB 316 and or transverse housing 311. In several embodiments, the left PCB 312 and the right PCB 314 are retained and supported by the U-shaped housing 305 (not visible in FIG. 5 but see FIG. 3) such that the combination of the left PCB 312, right PCB 314, transverse PCB 316, and U-shaped housing 305 create a fully defined containment and the transverse PCB 316 and U-shaped housing 305 create a position setting structure to locate and retain the left PCB 312 and right PCB 314 relative to the card reader.

In one embodiment, the security mesh 312a is a flexible grid capable of detecting puncture or other tampering. In several embodiments, the security mesh 312a is implemented as a matrix of conductive traces (e.g., copper). In another embodiment, the security mesh 312a is implemented as a matrix of conductive ink traces, such as with the Tamper Respondent Surface Enclosure of W.L. Gore and Associates of Elkton, Md.

In some embodiments, flexible circuits are used to connect various components with the card reader 300. For example, in one embodiment, a flexible circuit is used to couple the pad layout 310a of the zebra connector 310 with a smart card contact block 205. In several such embodiments, the flexible circuits can include a security mesh for detecting tampering. In one embodiment, the security mesh for the flexible circuits can be a matrix of flexible conductive traces (e.g., copper).

In the event that an attacker tampers with the security mesh 312a, the security mesh can send a signal to the processor 302 indicating the breach. In this case, tampering can include the puncture, tearing or other attempted breach of the mesh 312a. In one embodiment, the security mesh 312a can detect heat, electricity or other forms of tampering. The processor 302 can respond by initiating a destruction sequence that includes erasing encryption keys, memory and any other appropriate information. In such case, the processor 302 can also disable the encryption and/or magnetic sensor systems.

FIG. 6 is a perspective view of the secure fuel pump insertion card reader 300 of FIG. 3 with various components removed and the left PCB 312 made transparent to illustrate a zebra connector 310, the microswitch 308 and a first push button sensor 314c on the right PCB 314 for detecting tampering in accordance with one embodiment of the present invention. The zebra connector 310 includes an array of conductive pads 310a (not visible in FIG. 6 but see FIG. 4) positioned on the inside surface of the left PCB 312 that faces the right PCB 314. The zebra connector 310 also includes a matching array of conductive terminals and insulating material (possibly alternating the conductive terminals and the insulating material) that are configured to make un-bonded contact with the pad array 310a on the inside surface of the left PCB 312.

The zebra connector 310 can provide connectivity for one or more signals routed through the card slot housing 309, such as, for example, one or more signals passed from the smart card contact block (not visible in FIG. 6 but see FIG. 2) or other signals that need to be communicated to the processor on the left PCB 312. In addition, some contact elements on the zebra connector 310 may be dedicated to tamper detection such that any loss of the un-bonded contact along the zebra connector 310 is considered by the processor as actual or potential tampering. In a number of embodiments, the processor can take appropriate measures, as described above in the discussion of FIG. 1, in view of perceived tampering at the zebra connector 310.

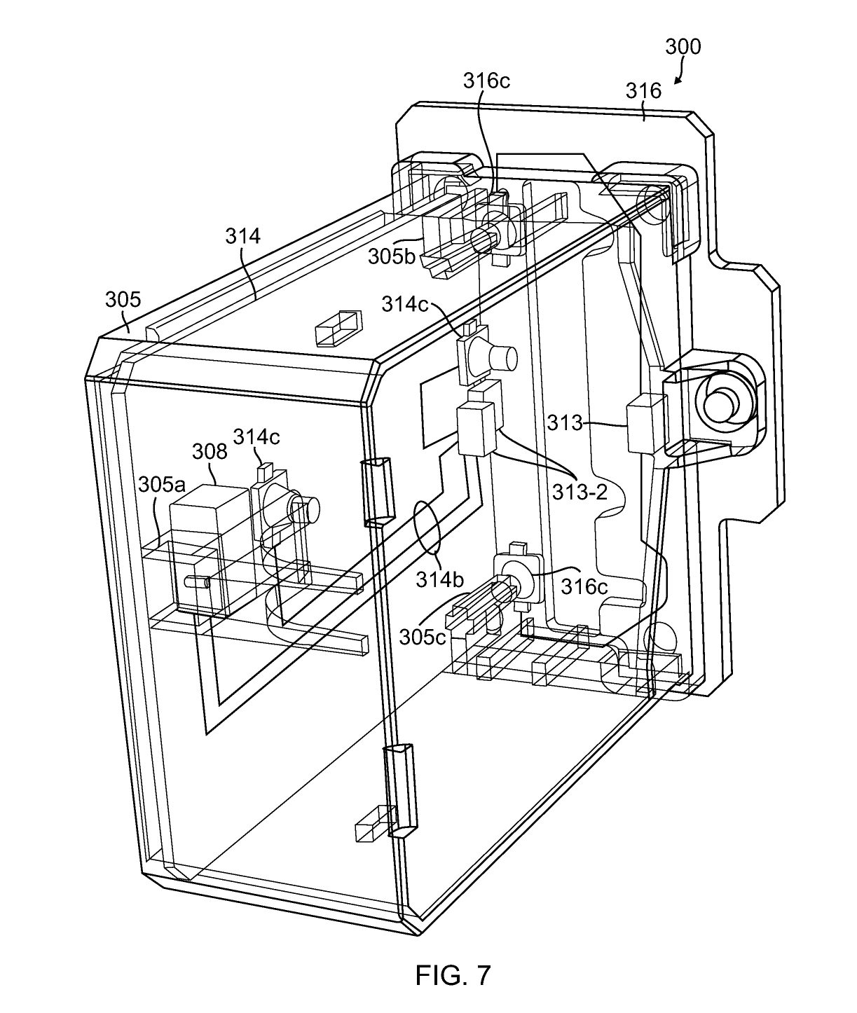

FIG. 7 is a perspective view of the secure fuel pump insertion card reader 300 of FIG. 3 with various components removed and the U-shaped housing 305 made transparent to illustrate the orientation of the microswitch 308 and various push button sensors (314c, 316c) in accordance with one embodiment of the present invention. As this FIG. 7 view illustrates, the housing 305 includes several sensor contacting structures for switching the microswitch 308 and push button sensors 316c into a housing installed position such that tampering may be detected if the housing is moved, detached, or partially removed. For example, sensor contacting structure 305a is positioned along the housing 305 such that it makes contact with an actuator button of the microswitch 308 when the housing 305 is mounted to the transverse PCB 316 (e.g., installed position). The housing also includes sensor contacting structures 305b and 305c for making contact and depressing push button sensors 316c mounted on the transverse PCB when the housing 305 is in the installed position. The right PCB 314 includes several traces 314b, which may be secure traces, for coupling the microswitch 308 and push button sensors 314c. The traces 314b are coupled to the transverse PCB 316 by another board to board connector 313-2 having components mounted on both the right PCB 314 and transverse PCB 316.

In one embodiment, the housing 305 is made of one or more suitable polymer materials. In one embodiment, the left PCB 312, the right PCB 314, and the transverse PCB 316 are made of suitable PCB materials known in the art. In one embodiment, the microswitch 308 is a KSR223GNCLFG microswitch provided by C&K Components of Newton, Mass. or a CL-DA-1CB4-A2T microswitch provided by Copal Electronics of Torrance, Calif. In one embodiment, the zebra connector 310 is a 5002-08.170.475 connector provided by Fujipoly America of Carteret, N.J. In one embodiment, the board to board interconnects (313, 313-2) are MMT-106-01-L-DH-K-TR and SMM-106-02-L-D-K-TR interconnects provided by Samtec USA of New Albany, Ind. In one embodiment, the push button switches (312c, 314c, 316c) are SK 3024010154011260 switches provided by Abatek (Americas), Inc. of Duluth, Ga. In one embodiment, the processor 302 is a IC0400C778BF+ provided by Maxim of Sunnyvale, Calif.

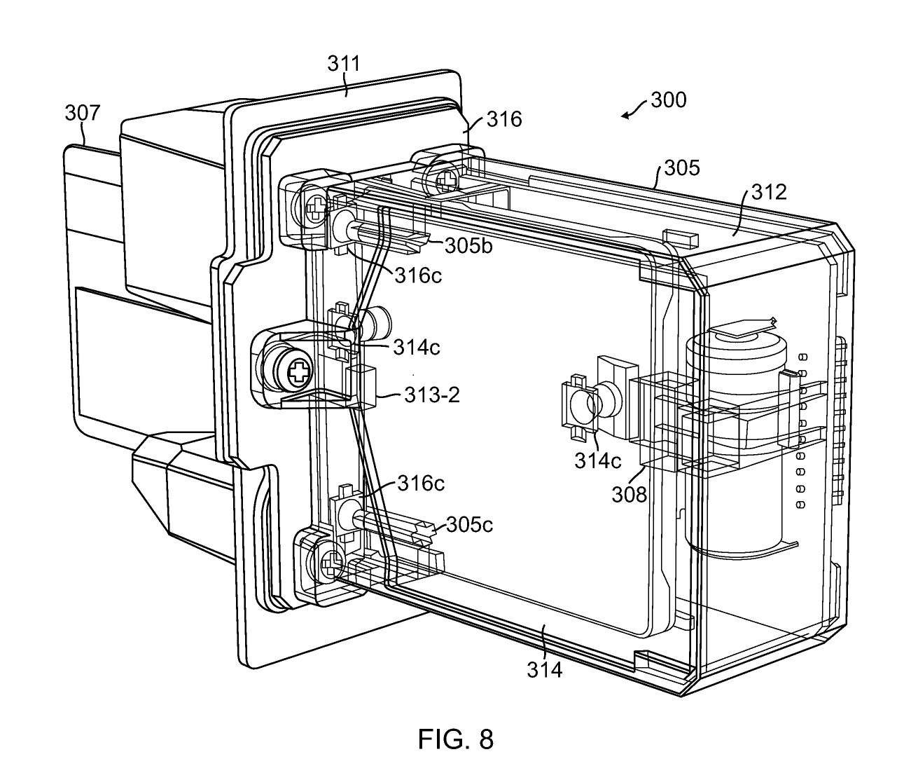

FIG. 8 is a perspective view of the secure fuel pump insertion card reader 300 of FIG. 3 with the U-shaped housing 305 and right PCB 314 made transparent to illustrate the microswitch 308 and various push button sensors (314c, 316c) in accordance with one embodiment of the present invention.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

What is claimed is:

1. A secure card reader for detecting and preventing tampering, the secure card reader comprising:
a reading head configured to extract recorded data from a data card;
a processing circuitry coupled to the reading head;
at least one printed circuit board comprising:
an inner surface and an outer surface, wherein the inner surface is closer to the processing circuitry than the outer surface;
at least one secure trace coupled to the processing circuitry; and
a security mesh coupled to the processing circuitry, wherein the security mesh is disposed between the secure trace and the outer surface; and
a housing, wherein the housing and the at least one printed circuit board form a compartment substantially enclosing the processing circuitry.

2. The secure card reader of claim 1, wherein the processing circuitry is configured to take protective measures if the security mesh is breached.

3. The secure card reader of claim 2, wherein the security measures comprise a measure selected from the group consisting of erasing a memory of the processing circuitry, entering a protective mode, and rendering the processing circuitry inoperative.

4. The secure card reader of claim 1, further comprising at least one tamper detection device coupled to the processing circuitry and configured to detect mechanical tampering with the secure card reader, wherein the compartment substantially encloses the at least one tamper detection device.

5. The secure card reader of claim 4, wherein the at least one tamper detection device is selected from the group consisting of a push button sensor, a zebra connector, a microswitch, and combinations thereof.

6. The secure card reader of claim 1, wherein the at least one printed circuit board comprises a first printed circuit board and a second printed circuit board.

7. The secure card reader of claim 6, wherein the processing circuitry is mounted to an inner surface of the first printed circuit board.

8. The secure card reader of claim 7, further comprising at least one push button sensor mounted to the first printed circuit board and coupled to the processing circuitry, wherein the at least one push button is configured to detect movement of the first printed circuit board.

9. The secure card reader of claim 7, further comprising:
a pad array mounted to the inner surface of the first printed circuit board and coupled to the processing circuitry, wherein the pad array is configured to make electrical and physical contact with a zebra connector; and
a card path housing positioned in the compartment and between the first printed circuit board and the second printed circuit board, wherein the zebra connector is mounted along the card path housing and configured to make contact with the pad array.

10. The secure card reader of claim 7, further comprising at least one push button sensor mounted to the second printed circuit board and coupled to the processing circuitry, wherein the at least one push button sensor is configured to detect movement of the second printed circuit board.

11. The secure card reader of claim 7, further comprising a microswitch mounted to the second printed circuit board and coupled to the processing circuitry, wherein the microswitch is configured to detect movement of the housing.

12. The secure card reader of claim 7, further comprising a third printed circuit board and at least one push button sensor mounted on the third printed circuit board, wherein the first printed circuit board is positioned about parallel to the second printed circuit board, and wherein the third printed circuit board is positioned about perpendicular to the first printed circuit board and the second printed circuit board.

13. The secure card reader of claim 12, wherein the at least one push button sensor is configured to detect movement of the housing.

14. The secure card reader of claim 1, wherein the reading head is configured to extract information from a magnetic medium of the data card, the information comprising the recorded data and an intrinsic magnetic characteristic of the magnetic medium, wherein the intrinsic magnetic characteristic comprises a remnant noise characteristic.

15. A secure card reader for detecting and preventing tampering, the secure card reader comprising:
a reading head configured to extract recorded data from a data card;
a processing circuitry coupled to the reading head;
a first printed circuit board and a second printed circuit board, each comprising:
an inner surface and an outer surface, wherein the inner surface is closer to the processing circuitry than the outer surface;
at least one secure trace coupled to the processing circuitry; and
a security mesh coupled to the processing circuitry, wherein the security mesh is disposed between the secure trace and the outer surface; and
a housing, wherein the housing and the first printed circuit board and the second printed circuit board form a compartment substantially enclosing the processing circuitry.

16. The secure card reader of claim 15, wherein the first printed circuit board is positioned about parallel to the second printed circuit board.

17. The secure card reader of claim 15, further comprising:
at least one first push button sensor mounted to the first printed circuit board; and
at least one second push button sensor mounted to the second printed circuit board.

18. The secure card reader of claim 17:
wherein the at least one first push button sensor is configured to detect movement of the first printed circuit board, and
wherein the at least one second push button sensor is configured to detect movement of the second printed circuit board.

19. The secure card reader of claim 15, further comprising:
a pad array mounted to the inner surface of the first printed circuit board and coupled to the processing circuitry, wherein the pad array is configured to make electrical and physical contact with a zebra connector;
a card path housing positioned in the compartment and between the first printed circuit board and the second printed circuit board, wherein the zebra connector is mounted along the card path housing and configured to make contact with the pad array.

20. The secure card reader of claim 15, further comprising a microswitch mounted to the second printed circuit board and coupled to the processing circuitry, wherein the microswitch is configured to detect movement of the housing.

21. The secure card reader of claim 15, wherein the reading head is configured to extract information from a magnetic medium of the data card, the information comprising stored data and an intrinsic magnetic characteristic of the magnetic medium, wherein the intrinsic magnetic characteristic comprises a remnant noise characteristic.

22. The secure card reader of claim 15, wherein the processing circuitry is configured to take protective measures if the security mesh is breached.

23. The secure card reader of claim 22, wherein the security measures comprise a measure selected from the group consisting of erasing memory of the processing circuitry, entering a protective mode, and rendering the processing circuitry inoperative.
